(19) United States
(12) Patent Application Publication
(10) Pub. No.: US 2009/0076422 A1
(43) Pub. Date: Mar. 19, 2009

(54) Smart acupressure pen and methods of administering acupressure

(75) Inventors: Thomas Kwok Shing Wong, Hong Kong (CN); Joanne Wai Yee Chung, Hong Kong (CN); Shing Yen Chan, Hong Kong (CN); Ka Ho Cheung, Hong Kong (CN); Wilson Sin Man Lee, Hong Kong (CN); Chung Hang Leung, Hong Kong (CN); Ka Lun Fan, Hong Kong (CN)

Correspondence Address: KAUTH , POMEROY , PECK & BAILEY ,LLP, P.O. BOX 19152, IRVINE, CA, 92623, US

(73) Assignee: The Hong Kong Polytechnic University, Hong Kong (HK)

(21) Appl. No.: 11/898,811

(22) Filed: Sep. 17, 2007

(51) Int. Cl. A61H 39/04

(52) U.S. Cl. 601/134; 606/204

(57) ABSTRACT

The present invention relates to an acupressure pen and methods of acupressure treatment, wherein said pen is capable of determining the optimal range for treatment on a particular acupoint, and recalling such optimal range during subsequent treatments. Through the use of a grid system, infrared communicator, and microcontroller, the pen is capable of being set and storing results in a matrix.

### BACKGROUND

Acupuncture points have been well known in China from earliest times and most of them are held to correspond to specific organs and areas of the body. Acupuncturists work by inserting needles of varying lengths at these points. When particular acupuncture points are stimulated, the corresponding areas being treated respond to the stimulation. Each acupuncture point occupies only a very small area, approximately half of a square millimeter on the skin surface. An acupuncture point is highly sensitive and the feeling elicited in respond to pressure is quite different from the surrounding tissues. The acupuncturist will, of course, insert his or her needle in such points but non-invasively pressing on the point can be almost as effective. After application of a therapeutic quantity of pressure to a particular acupuncture point of patients that suffer from a wide range of illnesses, including asthma, low-back pain, fatigue, weight reduction and so on, the length of time for which relief lasts will vary from patient to patient from a few minutes to several hours, or even days, but the effectiveness of the point will not diminish through use and the same result will be obtained time and time again.

Thus, it has become important to be able to deliver an accurately known pressure to a particular point upon the skin of the body in order to effect relief of pain and other symptoms.

U.S. Pat. No. 5,224,264 (**264) discloses a device for applying a therapeutic amount of pressure to the skin and underlying tissue. This device includes a pressure sensor for measuring the pressure on the patient's skin and underlying tissue. A digital controller monitors the pressure exerted or the skin and the elapsed time period during which the skin has been exposed to the measured pressure. When the pressure reaches a preset level, a timer starts. When the combination of pressure and elapsed time reaches a previously determined level, this is indicated by a digital readout device which converting the electrical signal into a visual display of the magnitude of the applied pressure.

The acupressure device mentioned in **264 uses force sensor to detect the applied force. However, the product that utilizes force sensors may be expensive and hazardous. On the other hand, the readout device of the acupressure device mentioned in **264 is separated from the acupressure pen and connected to the acupressure pen by means of electrical wires. This makes the device to be large in size and inconvenient for operating and carrying.

It is an object of the present invention to present a acupressure pen that overcomes the disadvantages and problems in the prior art, and methods of applying acupressure using the pen.

### DESCRIPTION

The present invention includes an acupressure pen and methods of using such pen. The pen and method provide a user-friendly and intellectual way of giving therapeutic treatments to patients suffering from a wide range of illnesses, such as different types of pains, weight reductions, fatigue, and others which can be overcome by acupoint stimulation.

These and other features, aspects, and advantages of the apparatus and methods of the present invention will become better understood from the following description, appended claims, and accompanying drawings where:

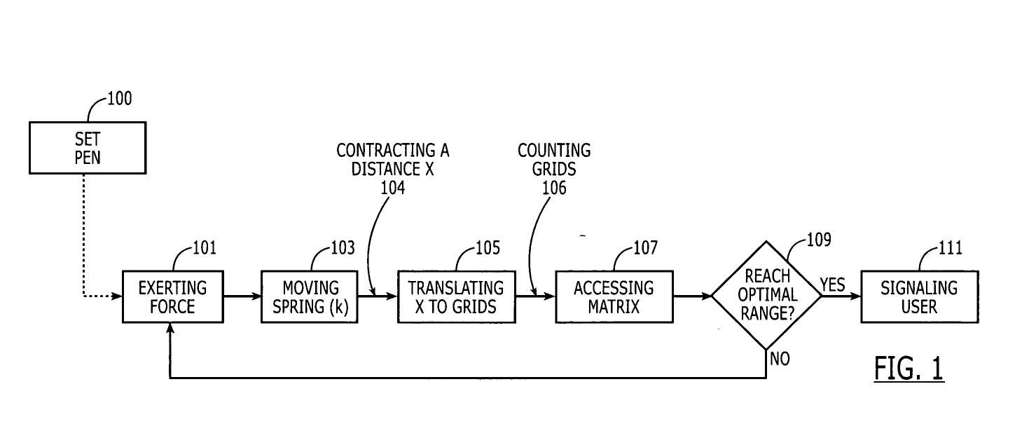

FIG. 1 shows a method of applying acupressure using the pen of the present invention;

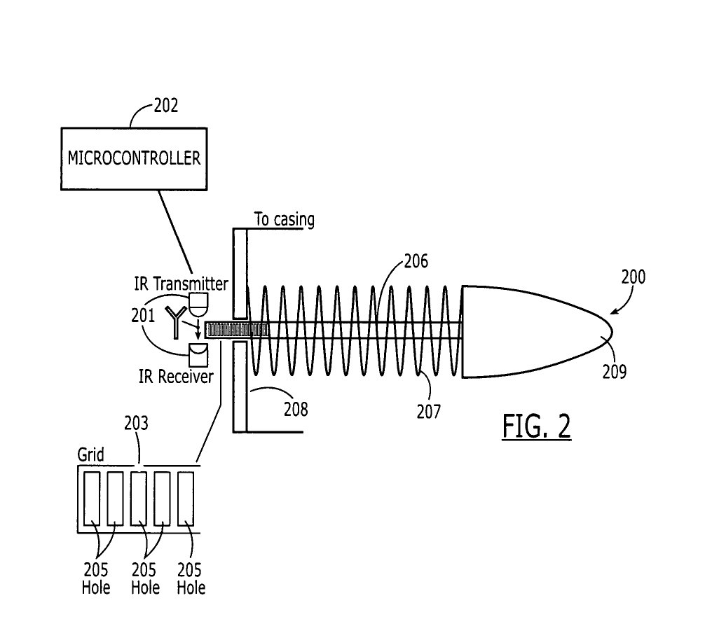

FIG. 2 shows the acupressure pen of the present invention;

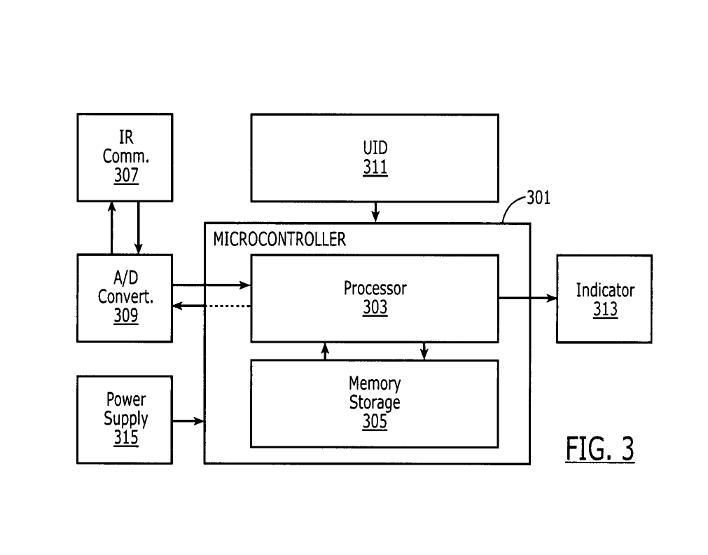

FIG. 3 is a embodiment of a schematic of the present invention;

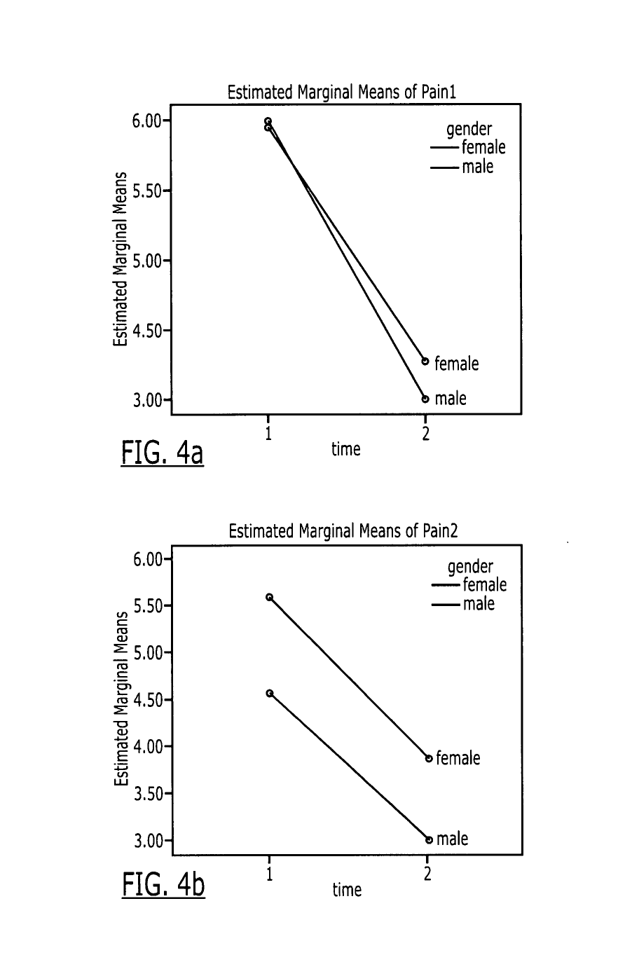

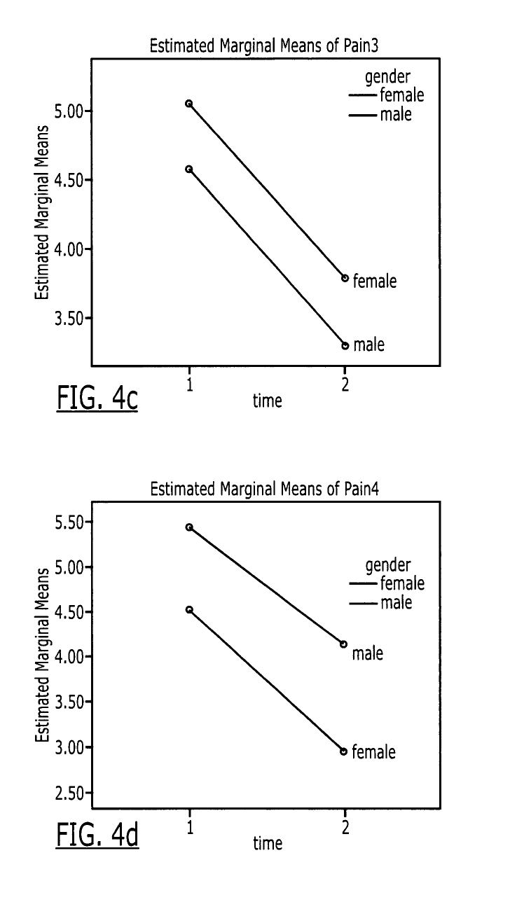

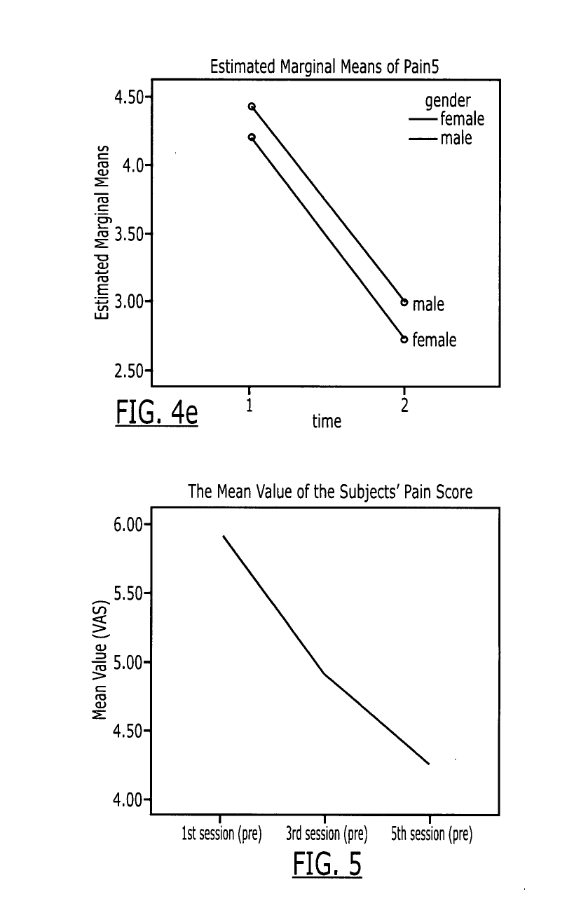

FIG. 4 exhibits the therapeutic efficacy of the present invention and method of alleviating neck pain;

FIG. 5 exhibits the mean value of the patient's pain score for neck pain;

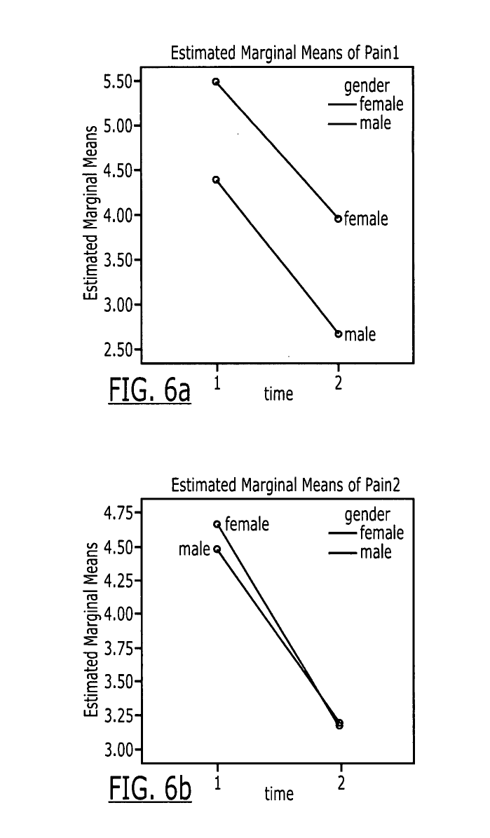

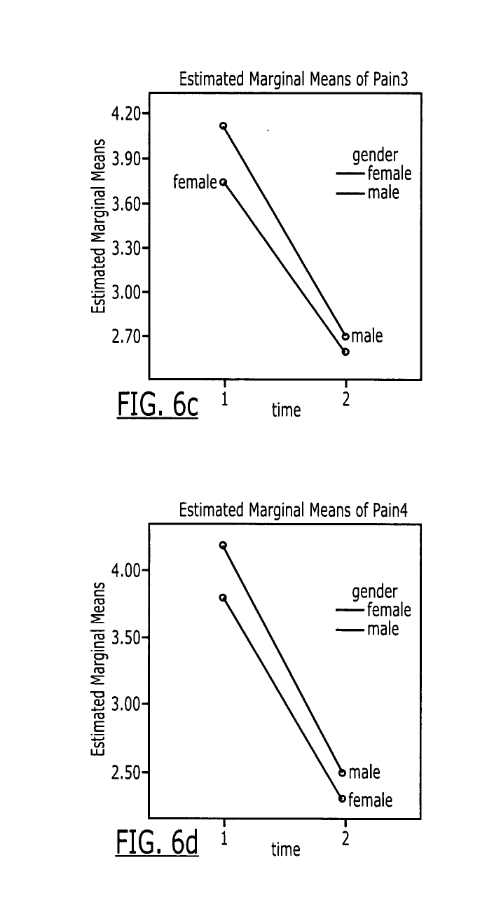

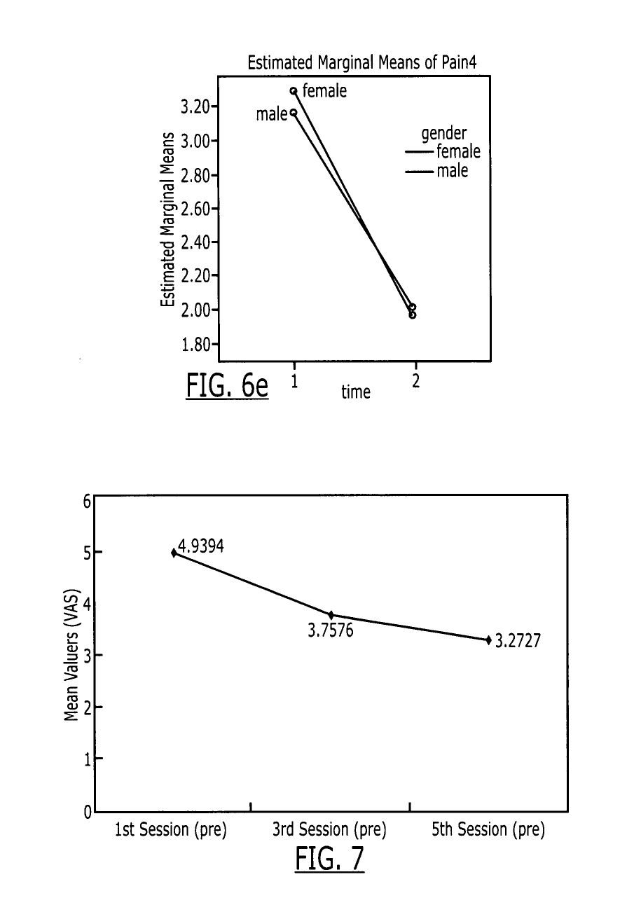

FIG. 6 exhibits the therapeutic efficacy of the present invention and method of alleviating low-back pain;

FIG. 7 exhibits the mean value of the patient's pain score for low-back pain.

The following description of certain exemplary embodiment(s) is merely exemplary in nature and is in no way intended to limit the invention, its application, or uses. Throughout this description, the terms “acupoint” and “acupressure points” shall refer to locations on the body that are the functions of acupressure, sonopuncture, and laser acupuncture treatments. The term “processor” shall refer to a component capable of performing calculations, keeping time, and processing data.

Now, to FIGS. 1-7,

The present invention relates to a method of using an acupressure pen for non-instrusive therapeutic treatment without piercing the skin. The method occurs through the measurement of force extended by the acupressure pen, and accessing recorded parameters, for examples optimal range of force and frequency of exertion, stored on the pen. The method relies upon knowledge of traditional Chinese medicine, specifically by focusing on acupoints on the body.

FIG. 1 is an embodiment of the method of the present invention.

Firstly, a force is exerted 101 upon an acupressure point of a patient. As known in the art, acupressure point under Traditional Chinese Medicine, are selected for their effectiveness in stimulating the meridian system to bring about relief by rebalancing yin, yang, and qi. Examples of acupressure points for treatment by the present method include but are not limited to those suitable for alleviating neck pain:
He Gu (L14): [symbol]
Hou XI (S13): [symbol]
Lei Que (LU7): [symbol]
Jian Jing (GB21): [symbol]
Feng Chi (GB20): [symbol]
Jian Wai Shu (S114): [symbol]
Jia Ji (EX-B2): [symbol]
and those suitable for low-back pain alleviation:
HeGU (L14): [symbol]
Yang Ling Quan (GB34): [symbol]
Cheng Shan (BL57): [symbol]
Kun Lun (BL6): [symbol]
San Jiao Shu (UB22): [symbol]
Shen Shu (UB23): [symbol]
Da Chang Shu (UB25): [symbol]
Wei-Zhong (UB20): [symbol]
Yaoyan (Ex-B7):

[symbol]

In exerting force 101, the tip of the pen of the present invention is pressed against the skin of a patient adjacent to one or more acupressure points. Force should be exerted in accordance with well-known acupressure techniques, for example exploring the bodily area with probing pressure, noticing jolts upon reaching an exact point, applying pressure between 15 seconds to 30 seconds, repeating application to the same point, etc.

The amount of force exerted upon the acupressure point can be limited, during the first treatment, to feedback observed from the patient. For example, yells, screams, or harsh words from the patient indicate that a more than suitable amount of force has been reached. During subsequent treatments, as will be discussed later, the amount of force applied to the acupressure point can be a pre-set amount, based upon feedback received during previous treatment.

Force should be measured in accordance with Hooke's Law:

F=KX where
F=force
K=spring constant and
X=measurement of spring contracting a distance

The moving spring 103 is accomplished through the pen of the present invention. A spring is disposed between the tip and the casing of the pen, and is compressed by the force applied on said tip, i.e., one end of the spring contacts with the tip and the other end of the spring is against the casing. The force applied to the tip derives from pressure applied to the acupressure points. Prior to compression, the spring can be considered to be in position X¹. Following compression, the spring can be considered to be in position X¹¹.

Upon being compressed, the spring is determined to control a distance X 104, previously defined, and mathematically defined as:

X=X¹−X¹¹

Following compression of the spring and determination of the contraction distance X 104, the contraction distance is translated to the grid system 105 of the pen. Translation 105 occurs by moving the grid system a distance equal to X. To be further discussed, the grid system includes a series of elongated holes placed on the base of the tips stem. At one end of the system, the tip for contacting acupressure points is connected thereto. At the other end is the grid system. The number of elongated holes can range from 2 to 200. The holes should preferably be equidistant apart, from approximately 0.5 μm to 5 μm apart.

The movement of the grid system leads to the counting of the number of holes the move past a point Y. The number of holes passing point Y can then the counted 106. The point Y is the point at which the Infrared transmitter of the pen sends a signal to the Infrared receiver of the pen. In use, as the grid system moves, the transmission from the transmitter to the receiver alternates from “successful transmission” to “unsuccessful transmission”. A “successful transmission” corresponds to an elongated hole passing through the point Y, i.e., there is nothing to impede the infrared transmission from passing through the grid system. The elongated holes can be counted 106 by a detector which records the number of “successful transmission” as the grid system moves.

Following counting of elongated holes 106, the pen accesses a matrix 107 stored on a memory. Accessing the matrix 107 can included retrieving information from the memory or storing information on the memory. In one embodiment, if the treatment of the acupressure point is the first time, measured information such as applied force as determined by counted number of grids and length of time for application of the force, can be stored on the memory. In another embodiment, if the treatment of the acupressure point is subsequent times, information stored in the matrix of the memory can be accessed, retrieving information such as previously applied force and length of time force was applied. Settings for the pen then be made from the retrieved information.

Following accessing the matrix 107, a determination is made as to whether the optimum range/treatment condition 100 has been sent. This usually occurs during subsequent treatments, i.e., after the first treatment. Reaching the optimum condition 109 occurs when the force is equal to the value stored on the memory. In the event, the optimum condition has been reduced, a feedback signal is sent to the user 111. A feedback signal can be, for example, sound or visual signed. If the optimum condition has not been reached, a signal is directed to the beginning of the process, requiring it to loop until the optimum condition is reached.

In one embodiment, in the event acupressure is being applied for a subsequent time after the first time, the pen can first be set 100. Setting the pen 100 can include accessing the matrix upon which are stored previously recorded optimum ranges. In another embodiment, setting the pen 100 can involve accessing a database stored on a removable storage media, such as a smart card or disk.

FIG. 2 is an acupressure pen 200 of the present invention, including a tip 209 at the front end of a shaft 206, a spring 207 around the shaft 206, a grid system 203 positioned at the back end of the shaft 206, an infrared communicator 201, and a microcontroller 202.

The acupressure pen 200 can further include various electrical components such as a battery unit, a sounding device, a visual indicator, display, user infrared devices such as buttons, and the like, designed allow a user-friendly pen 200.

The tip 209 is preferably a blunt end, capable of focusing on a acupressure point but incapable of piercing a patients skin. In one embodiment, the tip 209 is a flat end.

The tip 209 is connected to a shaft 206. The shaft 206 is movably connected to the pen 200, being capable of extending and retracting into the pen 200. The shaft 206 can be from about 1 cm to about 5 cm. The diameter of the shaft can be from 0.1 cm to 1 cm. As will be discussed later, the shaft 206 is capable of extending and retracting in a distance equal to the length of the grid system.

The spring 207, as previously discussed, is disposed between tip 209 and the casing wall 208. The spring 207 can be of the compression type, and be made of materials such as music wire, stainless steel, or plastic.

A grid system 203 includes a plastic strip and elongated holes 203 cut into the strip. The system 203 is positioned on the end of the shaft 206. As previously stated, the grid system 203 contains from 2 to 200 elongated holes 205 positioned from 0.5 μm to 5 μm, equidistant apart.

The grid system 203 interacts with the infrared communicator 201 when the pen 200 is in use. The infrared communicator 201 includes a transmitter and a receiver. The transmitter and the receiver are positioned on opposite sides of the path where the shaft 206 will retract to when the pen 200 is in use.

The pen 200 also includes a microcontroller, suitable for collecting data received during operation of the pen 200 and delivering information, including conditional operations, of the path. The microcontroller 202 also includes memory storage such as RAM, ROM, flash, etc. algorithms for operating the pen 200 may be stored on the memory. The microcontroller 202 can also act as a conduit between the pen 200 and user interface device or display (not shown). The microcontroller 202 is preferably stored within the housing of the pen 200.

FIG. 3 is an embodiment of a schematic of an acupressure pen in accordance with the present invention. As stated earlier, in a preferred embodiment, a microcontroller 301 is stored on the pen. The microcontroller 301 includes at least a processor 303 and a memory storage 305. The processor 303 can include a timer, calculation algorithms, controller algorithms, and the like useful for the operation of the pen. The memory storage is useful for recording information and delivering conditions to the processor 303 for setting the pen.

The microcontroller 307 primary function is setting conditions for the pen and passing results during treatment to the memory 305. The microcontroller 307 sets conditions for the pen and passes results through the infrared communicator 307. As the communicator 307 requires analog signals, a converter 309 is used as a go-between to convert signals from analog to digital and vice versa.

The user interface device (UID) 311 allows a use to set the conditions or, program the pen via the microcontroller. The UID 311 can include buttons, knobs, touch screen device, etc. The user interface device can also include additional drives, allowing removable data storage devices to be inserted into the system. In this way, the functionality of the pen can be expanded without modifying the internal components.

An indicator 313 id used to notify the user that a set condition has been reached. The indicator 313 can be audible or visual.

A power supply is also connected thereto. In one embodiment, power is direct current, such as battery supply.

In use, the pen allows a series of acupressure tips to be used to allow stimulation onto various types of acupoints. For example, acupoint groups have been developed for neck pain and for low-back pain. The programming stored on the pen can take into account factors such as body weight, height, BMI, etc. when setting conditions for treatment.

### EXAMPLE

Subjects were enrolled in the study in the following verifications:

| | No. of | Gender | Experimental | Control |
|---|---|---|---|---|
| Test Type | Subjects | Composition | Subjects | Subjects |
| Neck pain | 62 | 11 males, | 32 | 30 |
| | | 51 females | | |
| Low-back | 63 | 26 males, | 33 | 30 |
| pain | | 37 females | | |

The subjects were randomly allocated as either experimental subject or control one. Subjects of the experimental group were rendered 5 sessions of therapeutic treatment using the present pen, plus exercise, while those of the control group were only given exercise.

The following summarized parameters to be measured of each kind of verifications:

| Test Type | Subjective Parameters | Objective Parameters |
|---|---|---|
| Neck pain | Pain level in VAS | Rotational angle |
| | (Visual Analog | measurement (neck |
| | Scale) | flexion, extension) |
| | Neck Disability | Blood pressure |
| | Index (NDI) | (systolic/diastolic) |
| | | Pulse rate |
| Low-back | Pain level in VAS | Range of motion |
| pain | LBP Scale | Lift capacity test |
| | (Oswestry Low | Blood pressure |
| | Back Pain Scale) | (systolic/diastolic) |
| | | Pulse rate |

FIG. 4(a-e) shows the therapeutic efficacy in terms of pain level for neck pain.

FIG. 5 shows the overall picture of pain level for five sessions, showing a decline.

A summary of the VAS scale and NDI index is below:

| Parameters (Mean Values) | Female | Male | Total |
|---|---|---|---|
| Average Pain (VAS) | −1.55 | −1.51 | −1.54 |
| Pre-NDI | 13.45 | 12.71 | 13.28 |
| Post-NDI | 8.55 | 8.71 | 8.59 |
| NDI Difference | −4.91 | −4.00 | −4.69 |

Therapeutic efficacy of the pen is also signified by comparing overall rate pain level reduction between the experimental group and control group, as shown below:

| Parameters (Mean Values) | Control | Experimental |
|---|---|---|
| Pre-treatment VAS (1^{st} session) | 5.30 | 5.97 |
| Post-treatment VAS (1^{st} session) | 4.73 | 4.20 |
| Pre-treatment VAS (2^{nd} session) | 5.10 | 5.34 |
| Post-treatment VAS (2^{nd} session) | 4.53 | 3.66 |

FIG. 6(a-e) shows therapeutic efficacy of the pen for five treatment sessions of low-back pain.

FIG. 7 depicts the overall pain level for five sessions, showing a trend to decline.

The summary of the rate of reduction of VAS scale and LBP scale is tabulated below:

| Parameters (Mean Values) | Female | Male | Total |
|---|---|---|---|
| Average Pain (VAS) | −1.38 | −1.48 | −1.42 |
| Pre-LBP Scale | 17.35 | 13.92 | 15.93 |
| Post-LBP Scale | 12.00 | 8.08 | 10.38 |
| LBP Scale Difference | −5.35 | −5.83 | −5.55 |

The therapeutic efficacy between the experimental group and the control is shown below:

| Parameters (Mean Values) | Control | Experimental |
|---|---|---|
| Pre-treatment VAS (1^{st} session) | 5.03 | 5.03 |
| Post-treatment VAS (1^{st} session) | 4.83 | 3.41 |
| Pre-treatment VAS (2^{nd} session) | 4.63 | 4.59 |
| Post-treatment VAS (2^{nd} session) | 4.53 | 3.17 |

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. An acupuncture pen comprising,
a casing;
a movable shaft;
a tip positioned on the top of said shaft;
a spring positioned around said shaft;
a grid system having between 2 to 200 elongated holes positioned on the bottom of said shaft;
and
an infrared communicator.

2. The acupuncture pen in claim 1, further comprising a microcontroller, a power supply, and an analog/digital converter.

3. The acupuncture pen in claim 2, wherein said microcontroller comprises a processor, a memory, and a user interface device.

4. The acupuncture pen in claim 1, further comprising an indicator.

5. The acupuncture pen in claim 1, wherein said shaft is from 1 cm to 5 cm in length.

6. The acupuncture pen in claim 1, wherein said grid system is a plastic strip.

7. The acupuncture pen in claim 1, wherein said infrared communicator comprises an infrared transmitter and an infrared receiver.

8. The acupuncture pen in claim 3, further comprising acupressure treatment algorithms.

9. The acupuncture pen in claim 2, further comprising a slot for accepting removable storage media.

10. The acupuncture pen in claim 3, wherein said memory comprises a matrix possessing conditional operations for acupressure pen.

11. A method of treating pain using an acupressure pen, comprising the steps:
exerting a force on a acupoint from an acupressure pen;
moving a spring;
contracting said spring a distance X;
translating said distance X to a grid system;
counting grids on said grid system;
accessing a matrix;
and
IF an optimal range is reached, THEN signaling user; or
IF an optimal range is not reached, THEN re-exerting said force.

12. The method of treating pain using an acupressure pen in claim 11, wherein exerting said force comprises applying pressure to said acupoint.

13. The method of treating pain using an acupressure pen in claim 11, wherein moving said spring comprises compressing said spring.

14. The method of treating pain using an acupressure pen in claim 11, wherein contracting a distance X comprises said spring moving from a position X¹ to a position X¹¹.

15. The method of treating pain using an acupressure pen in claim 11, wherein translating said distance X to said grid system comprises said grid system moving simultaneously with said contacting spring.

16. The method of treating pain using an acupressure pen in claim 11, wherein counting grids comprises counting the “successful transmission” occurring between an infrared transmitter and infrared receiver positioned on either side of said grid system.

17. The method of treating pain using an acupressure pen in claim 11, wherein accessing said matrix comprises communication between an infrared communicator and a microcontroller via an analog/digital converter.

18. The method of treating pain using an acupressure pen in claim 11, further comprising the step of
storing said optimal range on a memory of a microcontroller.
